(19) United States
(12) Patent Application Publication
(10) Pub. No.: US 2019/0151175 A1
(43) Pub. Date: May 23, 2019

(54) CONNECTOR SYSTEM

(71) Applicant: HUNTLEIGH TECHNOLOGY LIMITED, BEDFORDSHIR (GB)

(72) Inventors: Randall Paul KELCH, San Antonio, TX (US); Glenn C. STROH, Marion, TX (US); Kenneth Michel KNOWLES, Bandera, TX (US)

(73) Assignee: HUNTLEIGH TECHNOLOGY LIMITED, BEDFORDSHIRE (GB)

(21) Appl. No.: 15/505,082

(22) PCT Filed: Aug. 18, 2015
(86) PCT No.: PCT/US2015/045771

§ 371 Date: Feb. 18, 2017

Related U.S. Application Data
(60) Provisional application No. 62/038,821, filed on Aug. 18, 2014.

(51) Int. Cl. A61G 7/057; A61G 7/00; A47C 27/08

(52) U.S. Cl. CPC A61G 7/05776; A47C 27/082; A61G 7/001

(57) ABSTRACT

The present application is directed to a connector system of a patient support apparatus for inflating and/or deflating a mattress and facilitating the installation, detachment and interchange of various inflatable mattresses of the patient support apparatus, particularly inflatable mattresses for hospital beds.

### CROSS-REFERENCE TO RELATED APPLICATIONS

This application claims the benefit of priority to provisional U.S. Patent Application Ser. No. 62/038,821, filed Aug. 18, 2014 which is herein incorporated by reference in its entirety.

### BACKGROUND OF THE INVENTION

### 1. Field of the Invention

The present application pertains to a connector system for inflating and/or deflating a mattress of a patient support apparatus. The connector system may be useful for facilitating the installation, detachment, and interchange of various inflatable mattresses, particularly hospital bed mattresses configured for long-term care that prevent, reduce or treat decubitus ulcers, facilitate patient turning and/or otherwise facilitate repositioning a patient.

### 2. Description of the Related Technology

Conventional hospital beds typically have either an integrated inflatable mattress or a stand-alone inflatable mattress, each of which comes with various tradeoffs. Systems in which an inflatable mattress is permanently affixed to a bed frame are often complex structures that can be difficult to clean, sterilize and maintain. Furthermore, these beds cannot be used with other mattresses. As such, they have limited utility when the particular features of the integrated mattress are not therapeutically needed, desired or relevant.

Stand-alone inflatable mattresses removably positioned on a hospital bed often lack means for sufficiently securing the mattress to the bed. Additionally, they generally lack the capability and system integration necessary to interface with and obtain patient or system related information from the bed useful to improve overall patient therapy. These systems can also be cumbersome, typically requiring an external inflation control unit and a large pneumatic hose encircling the perimeter of the bed. Furthermore, numerous mattress inflation ports are generally widely sprawled throughout these systems rendering them difficult to install and remove.

In view of the above, there is a need to develop a modular patient support apparatus that allows for rapid connection, detachment and interchange of various inflatable mattresses with respect to a bed frame without the need for cumbersome equipment or complicated installation and removal procedures.

### SUMMARY OF THE INVENTION

An inflatable mattress according to an example embodiment of the present application includes a patient support surface; a mattress base opposing the patient support surface; and a connector assembly disposed through the mattress base. The connector assembly includes one or more connector plates including a plate body and one or more conduit connectors having an end detachably connectable to an inflation manifold of a bed deck. The one or more conduit connectors are positioned through and movably attached to the connector plate.

According to an example embodiment, the connector assembly further includes a plurality of the one or more conduit connectors positioned through one or more openings of the one or more connector plates. Each conduit connector is movably connectable to the one or more connector plates and independently movable with respect to one another.

According to an example embodiment, at least one of the conduit connectors is pivotally connectable to the one or more connector plates and/or movably attachable to the one or more connector plates so as to be capable of lateral displacement within the one or more openings.

According to an example embodiment, at least one of the conduit connectors further includes an elongated body and a rigid flange extending from an exterior surface of the elongated body towards the portion of the one or more connector plates defining the one or more openings. The elongated body is spaced apart from the portion of the one or more connector plates defining the one or more openings.

According to an example embodiment, the one or more connector plates further include an upper plate member and a lower plate member with the one or more openings defined therethrough. The flange is movably secured between a portion of the upper and lower plate members defining the one or more openings.

According to an example embodiment, the flange can move laterally about 1 mm or more in a space between the upper and lower plate members.

According to an example embodiment, the connector assembly further includes a fastener capable of reversibly locking the connector assembly to the inflation manifold. The fastener includes an actuator located within an interior space of the mattress and accessible through a sealable opening of the mattress.

According to an example embodiment, the connector assembly further includes a fastener capable of reversibly locking the connector assembly to the inflation manifold. The fastener is spaced apart from the conduit connectors, extends through the one or more connector plates and is capable of engaging the inflation manifold.

According to an example embodiment, the fastener is selected from the group consisting of a threaded fastener, a latch, and a hook.

According to an example embodiment, the plurality of conduit connectors are arranged in a group in the one or more connector plates, and the connector assembly centralizes a location of inflation port inlets of the mattress.

According to an example embodiment, the mattress further includes a plurality of the one or more inflatable cells. The connector assembly is in fluid communication with at least substantially all of the inflatable cells of the mattress that affects a shape and/or contour of the patient support surface.

A system according to an example embodiment of the present application includes any of the foregoing the mattresses and a bed deck supporting the inflatable mattress, wherein the inflation manifold is disposed at least partially within the bed deck.

According to an example embodiment, the system further includes an inflation control unit and a conduit extending between the inflation control unit and the inflation manifold to deliver a fluid from the inflation control unit to the inflation manifold for inflating the mattress.

An inflatable mattress for supporting a patient according to an example embodiment of the present application includes: one or more inflatable cells, a patient support surface, a mattress base opposing the patient support surface and a connector assembly disposed through the mattress base. The connector assembly includes one or more connector plates having a plate body, and one or more conduit connectors positioned through the one or more connector plates. The connector assembly is configured to be rapidly and detachably connectable to an inflation manifold of a bed deck. The mattress further includes one or more conduits extending from the one or more conduit connectors to the one or more inflatable cells for inflating and/or deflating the mattress.

According to an example embodiment, the mattress further includes a mattress cover, wherein the connector assembly is disposed through the mattress cover at the mattress base and wherein the one or more inflatable cells are at least partially positioned within the interior space of the mattress cover at a location spaced apart from the connector assembly.

According to an example embodiment, the connector assembly further includes a fastener capable of reversibly locking the connector assembly to the inflation manifold, wherein the fastener includes an actuator located within an interior space of the mattress and accessible through a sealable opening of the mattress.

According to an example embodiment, the connector assembly further includes a fastener capable of reversibly locking the connector assembly to the inflation manifold, wherein the fastener is spaced apart from the conduit connector and extends through the one or more connector plates and is capable of engaging the inflation manifold.

According to an example embodiment, the fastener is selected from the group consisting of a threaded fastener, a latch and a hook.

According to an example embodiment, the connector assembly further includes a plurality of the one or more conduit connectors extending through one or more openings of the one or more connector plates. The mattress includes a plurality of the one or more inflatable cells and a plurality of the one or more inflation cell conduits extending from the plurality of conduit connectors to the plurality of the inflatable cells.

According to an example embodiment, the plurality of conduit connectors are arranged in a group in the one or more connector plates, and the connector assembly centralizes a location of inflation inlet ports of the mattress.

According to an example embodiment, the plurality of conduit connectors is arranged in one or more rows in the connector plate, and the plurality of conduits extending from the plurality of conduit connectors to the plurality of inflatable cells can be arranged so as not to cross over one another.

According to an example embodiment, the inflatable mattress further includes a plurality of the one or more inflatable cells and wherein the connector assembly is in fluid communication with at least substantially all of the inflatable cells of the mattress that affects a shape and/or contour of the patient support surface.

According to an example embodiment, the connector assembly further includes a plurality of the one or more conduit connectors, each movably connected to the one or more connector plates and independently movable with respect to one another.

According to an example embodiment, the one or more conduit connectors further includes an elongated body and a rigid flange extending from an exterior surface of the elongated body towards a portion of the one or more connector plates defining the one or more openings, wherein the elongated body is spaced apart from the portion of the one or more connector plates defining the one or more openings.

A patient support system according to an example embodiment of the present application includes any of the foregoing mattresses and a bed deck supporting the mattress, wherein the system further includes a bed base, wherein the inflation manifold is disposed at least partially within the bed deck, and wherein the one or more conduit connectors include a quick connect fastener end capable of being rapidly and detachably coupled to the inflation manifold.

According to an example embodiment, the system further includes an inflation control unit and one or more conduits extending between the inflation control unit and the inflation manifold to deliver a fluid from the inflation control unit to the inflation manifold for inflating the one or more inflatable cells.

A bed deck of a hospital bed according to an example embodiment of the present application includes: a platform body for supporting a length of an inflatable mattress; one or more openings defined in an upper surface of the platform body; and a manifold assembly disposed at least partially within the platform body. The manifold assembly includes: one or more inflation manifolds including one or more manifold chambers, wherein a fastener end of the one or more manifold chambers are adjacent to and accessible through the one or more openings and is configured to rapidly and detachably couple to one or more mattress conduit connectors for inflating the mattress. The bed deck further includes one or more manifold conduit connectors extending from the manifold chambers and through a lower surface of the platform body.

According to an example embodiment, the one or more inflation manifolds include a plurality of the one or more manifold chambers arranged in a group in the platform body and wherein the manifold assembly centralizes a location of inflation port outlets of the bed deck for inflating the mattress.

According to an example embodiment, the platform body includes a recess for receiving and engaging a portion of a connector plate of the mattress containing the one or more mattress conduit connectors and wherein the one or more openings is defined within the recess.

According to an example embodiment, the manifold assembly further includes a manifold cover pivotally attached to the platform body and capable of being adjustably positioned over the fastener end of the one or more manifold chambers.

According to an example embodiment, the manifold assembly further includes a fastener mating feature spaced apart from the manifold chambers to lock the connector assembly to the inflation manifold.

A patient support system according to an example embodiment of the present application includes any of the foregoing bed decks and a mattress, wherein one or more mattress conduit connectors include a quick connect fastener end capable of being rapidly and detachably coupled to the one or more manifold chambers.

According to an example embodiment, the patient support system further includes an inflation control unit and one or more conduits extending between the inflation control unit and the one or more manifold conduit connectors to deliver a fluid from the inflation control unit to the inflation manifold for inflating the mattress.

A patient support system according to an example embodiment of the present application includes: an inflatable mattress for supporting a patient and a bed deck forming a mattress supporting platform of a bed frame. The inflatable mattress includes a patient support surface; a mattress base opposing the patient support surface; and a connector assembly disposed through the mattress base. The connector assembly includes a plurality of conduit connectors detachably connectable to an inflation manifold for inflating the mattress, wherein the plurality of conduit connectors are arranged in a group and wherein the connector assembly centralizes a location of inflation port inlets of the mattress. The mattress is positioned on the bed deck, and the bed deck includes one or more inflation manifolds accessible through an upper surface of the bed deck and detachably coupled to the plurality of conduit connectors.

According to an example embodiment, the one or more manifolds includes a plurality of manifold chambers detachably connectable to the plurality of conduit connectors. When the connector assembly is attached to the one or more inflation manifolds, the plurality of conduit connectors are aligned with the plurality manifold chambers.

According to an example embodiment, the plurality of manifold chambers is arranged in a group corresponding to the grouping of the plurality of conduit connectors so as to localize a location of inflation ports of the bed and mattress.

According to an example embodiment, each of the plurality of conduit connectors includes a quick connect fastener end capable of being rapidly and detachably coupled to the one or more manifold chambers.

According to an example embodiment, the mattress further includes a plurality of the one or more inflatable cells. The connector assembly and the one or more inflation manifolds are in fluid communication with at least substantially all of the inflatable cells of the mattress that affect a shape and/or contour of the patient support surface.

According to an example embodiment, the connector assembly further includes one or more connector plates with one or more openings through which the plurality of conduit connectors are positioned. When the connector assembly is attached to the one or more inflation manifolds, the plurality of conduit connectors are aligned with the one or more openings defined in the upper surface of the bed deck.

According to an example embodiment, the connector assembly further includes one or more connector plates. The plurality of conduit connectors are movably connected to the one or more connector plates and independently movable with respect to one another.

According to an example embodiment, the connector assembly further includes one or more connector plates with one or more openings defined therein through which the plurality of conduit connectors are positioned, and wherein at least one of the conduit connectors includes an elongated body and a rigid flange extending from an exterior surface of the elongated body towards a portion of the one or more connector plates defining the one or more openings, wherein the elongated body is spaced apart from the portion of the one or more connector plates defining the one or more openings.

According to an example embodiment, the mattress further includes a plurality of inflatable cells in fluid communication with the plurality of conduit connectors.

According to an example embodiment, the patient support system further includes a fastener for locking the connector assembly to the one or more inflation manifolds. The fastener is spaced apart from the plurality of conduit connectors and a corresponding plurality of manifold chambers of the one or more inflation manifolds, and wherein a portion of the fastener is located within an interior space of the mattress accessible through a resealable opening of the mattress.

According to an example embodiment, the bed deck further includes a recess for receiving and engaging a portion of the connector assembly of the mattress, wherein the one or more openings of the bed deck are formed in the recess.

According to an example embodiment, the manifold assembly further includes one or more manifold cover pivotally attached to the platform body and capable of being adjustably positioned over the one or more inflation manifolds.

According to an example embodiment, the patient support system further includes another inflatable mattress having a different structural or therapeutic feature and including another of the connector assemblies interchangeable connectable to the inflation manifold of the bed deck.

A method for using a patient support system according to an example embodiment of the present application involving: coupling a plurality of conduit connectors of a connector assembly disposed through a mattress base of an inflatable mattress to a corresponding plurality of manifold chambers of one or more inflation manifold of a bed deck, wherein the step of coupling includes placing the mattress on or above the bed deck such that the plurality of conduit connectors are aligned with the plurality of manifold chambers; and simultaneously inserting the plurality of conduit connectors into the plurality of manifold chambers.

According to an example embodiment, the method further involves locking the connector assembly to the one or more inflation manifolds by attaching a fastener of the connector assembly to the one or more inflation manifolds, wherein the fastener is spaced apart from the plurality of conduit connectors and the plurality of manifold chambers.

According to an example embodiment, the method further involves opening a portion of the mattress to access the fastener located within an interior space of the mattress and subsequently closing the opening of the mattress after attaching the connector assembly to the one or more inflation manifolds.

According to an example embodiment, the method further involves delivering fluid through the connected plurality of manifold chambers and the plurality of conduit connectors to inflate the mattress.

According to an example embodiment, the mattress further includes a plurality of independently inflatable cells, and the step of delivering fluid to inflate the mattress includes delivering the fluid from the plurality of manifold chambers and the plurality of conduit connectors to the plurality of independently inflatable cells.

According to an example embodiment, the method further involves adjusting the configuration of a patient support surface of the mattress by periodically adjusting the fluid pressure, degree of inflation, the rate of inflation and/or the relative timing of inflation of the one or more of the independently inflatable cells.

According to an example embodiment, the method further involves deflating the mattress by releasing the fluid in the mattress through a dump valve operatively associated with the inflation manifold.

According to an example embodiment, the method further involves removing the deflated mattress from the bed base by detaching the fastener from the one or more inflation manifold and lifting the plurality of conduit connectors with respect to the plurality of manifold chambers to uncouple the connector assembly from the one or more inflation manifolds.

According to an example embodiment, the method further involves interchanging the mattress coupled to the bed deck with another inflatable mattress having a different structural configuration and another of the connector assembly.

A patient support system according to an example embodiment of the present application includes an inflatable mattress for supporting a patient and a bed deck forming a mattress supporting platform of a bed frame. The inflatable mattress includes a plurality of inflatable cells; a patient support surface; a mattress base opposing the patient support surface; and a connector assembly disposed through the mattress base. The connector assembly includes a plurality of conduit connectors in fluid communication with the plurality of inflatable cells and is detachably connectable to an inflation manifold for inflating the mattress, wherein the connector assembly centralizes a location of inflation port inlets of the mattress. The mattress is positioned on the bed deck, wherein the bed deck includes one or more inflation manifolds accessible through an upper surface of the bed deck and detachably coupled to the plurality of conduit connectors. When the connector assembly is attached to the one or more inflation manifolds, the plurality of conduit connectors are aligned with and detachably coupled to a plurality manifold chambers of the one or more inflation manifolds.

The patient support system further includes a fastener for locking the connector assembly to the one or more inflation manifolds, wherein the fastener is spaced apart from the plurality of conduit connectors and the plurality of manifold chambers of the one or more inflation manifolds, and wherein a portion of the fastener is located within an interior space of the mattress accessible through a resealable opening of the mattress.

### BRIEF DESCRIPTION OF THE DRAWINGS

FIG. 1 is a perspective view of an exemplary patient support system, including a partial sectional detail view of the connector assembly and bed deck.

FIG. 2 is a perspective view of an exemplary bed frame of the patient support system of FIG. 1.

FIGS. 3A-B are schematic diagrams of exemplary mattresses usable with a patient support system of FIG. 2, including a plurality of different inflatable cells in fluid communication with a connector assembly.

FIG. 4 is a detailed and partially exploded top view of a foot support region and exemplary connector system of the patient support system of FIG. 1.

FIG. 5 is a detailed and partially exploded bottom view of a foot support region and connector system of the patient support system of FIG. 4.

FIG. 6 is a top view of a portion of an exemplary connector assembly of FIGS. 4-5, showing one connector plate, a set of conduit connectors and a set of system fasteners.

FIG. 7 is a top perspective view of the connector assembly portion of FIG. 6.

FIG. 8 is a bottom perspective view of the connector assembly portion of FIG. 6.

FIG. 9 is a cross-sectional view through sectional line A-A of the connector assembly portion of FIG. 6.

FIG. 10 is an elevated perspective view showing a portion of a bed frame foot support region and exemplary manifold assembly of FIG. 1.

FIG. 11 is a perspective view showing an exemplary connector assembly coupled to an exemplary manifold assembly portion.

FIG. 12 is a close-up partial perspective view of FIG. 11 showing a connector assembly portion coupled to an exemplary manifold assembly portion.

FIG. 13 is a cross-sectional view showing the connector assembly and manifold assembly portions of FIG. 11 through the sectional plane B-B.

FIG. 14 is a cross-sectional view showing the connector assembly and manifold assembly portions of FIGS. 11 and 12 through sectional line C-C with the dump valve in the closed position.

FIG. 15 is a cross-sectional view showing the connector assembly and manifold assembly portions of FIGS. 11 and 12 through line sectional C-C with the dump valve in the open position.

### DETAILED DESCRIPTION OF THE PREFERRED EMBODIMENTS

For illustrative purposes, the principles of the present application are described by referencing various exemplary embodiments. Although certain embodiments of the application are specifically described herein, one of ordinary skill in the art will readily recognize that the same principles are equally applicable to, and can be employed in other systems and methods. Before explaining the disclosed embodiments of the present application in detail, it is to be understood that the present disclosure is not limited in its application to the details of any particular embodiment shown. Additionally, the terminology used herein is for the purpose of description and not of limitation. Furthermore, although certain methods are described with reference to steps that are presented herein in a certain order, in many instances, these steps may be performed in any order as may be appreciated by one skilled in the art; the novel method is therefore not limited to the particular arrangement of steps disclosed herein unless clearly expressed otherwise.

For purposes of the present application, “fluid” as used herein, refers to any liquid or gas suitable for use as an inflation medium, including but not limited to air.

As used herein, “localized” refers to the positioning of multiple items, such as ports, first conduit members, connector plate openings and/or connector plates, each item located within an immediate vicinity of one another so as not to be spread out along the perimeter or a substantial length of the mattress. In one exemplary embodiment, the fluid inflation ports, conduit connectors and connector plate openings of a patient support system may be localized so as to be positioned within an area having a radius of about 30.5 cm or less or about 46 cm or less. The localized grouping these various items may be described in terms of an area having a width or length expressed as a percentage of the length or width of a mattress. For example, at least substantially all of the fluid inflation ports, conduit connectors and connector plate openings of a patient support system may be arranged in an area having a width of about 60%, 55%, 50%, 45%, or 40% or less of the mattress width. In another embodiment, at least substantially all of the fluid inflation ports, conduit connectors and connector plate openings of a patient support system may be arranged in an area having a length of about 30%, 25%, 20%, 15%, 10%, 5% or 2.5% or less of the mattress length. In yet another embodiment, a localized area having any combination of the aforementioned widths and lengths are feasible. For example, in one embodiment, at least substantially all of the fluid inflation ports, conduit connectors and connector plate openings of a patient support system may be located in an area having a width of about 31% or less of a mattress's width and a length of about 16% or less of a mattress's length. The referenced length or width of the mattress may refer to an average or maximum length or width of the mattress.

The present application is directed to a novel connector system for use in inflating a mattress of a patient support apparatus and corresponding methods for use thereof. In an exemplary embodiment, the connector system facilitates the rapid, secure and detachable connection of a portion of the inflatable mattress to a portion of the bed frame in an efficient and organized manner via a connector system that enables fluid transport therebetween for purposes of inflating and/or deflating the mattress. This connection scheme further facilitates the rapid and interchangeable coupling of various mattresses and bed frames to one another allowing for customized patient care.

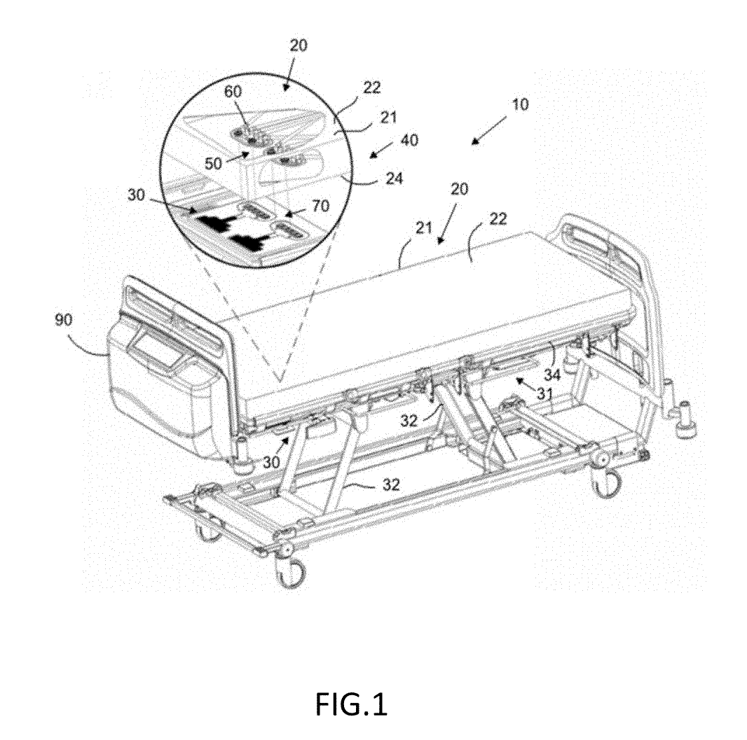

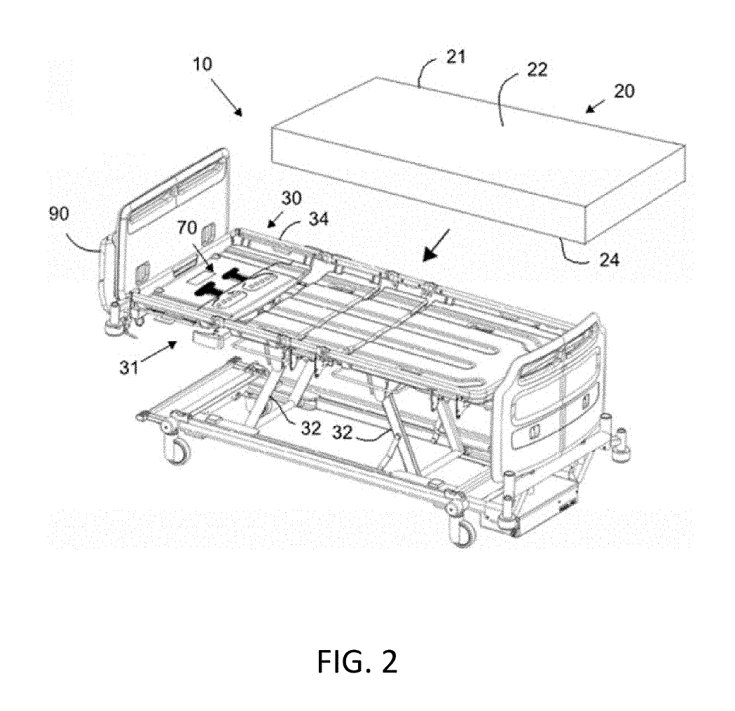

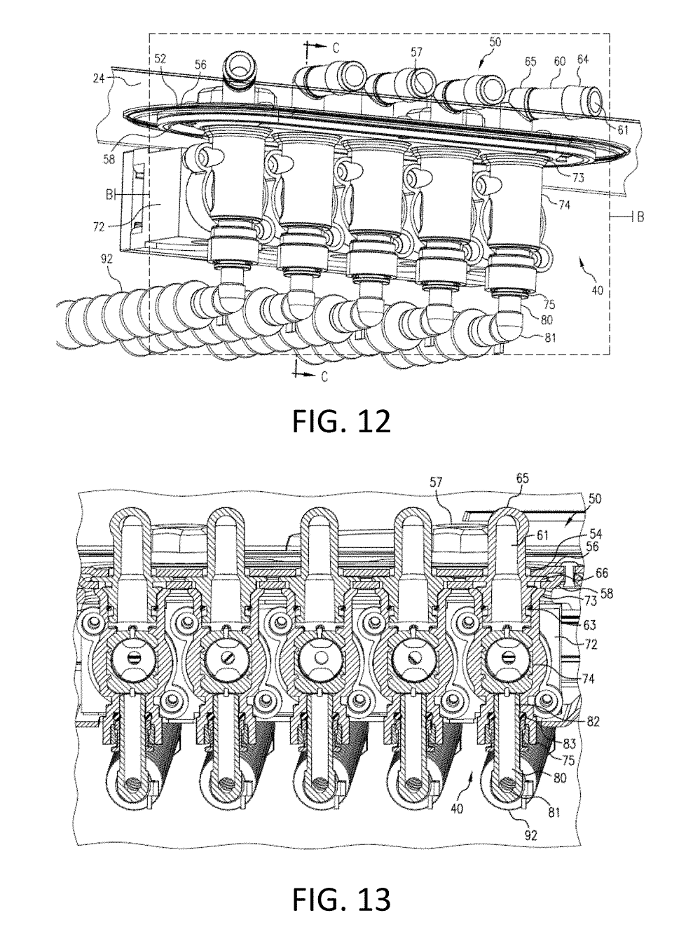

Referring now to the exemplary embodiments shown in FIGS. 1-15 and in particular FIGS. 1-2, a connector system 40 of the present application may be arranged between any two surfaces, such as the illustrated inflatable mattress 20 and bed deck 30 of a patient support system 10 to establish fluid communication therebetween for purposes of inflating and/or deflating mattress 20. Connector system 40 may include a connector assembly 50 at least partially disposed in mattress 20 and a manifold assembly 70 at least partially disposed within bed deck 30 that are detachably connectable to one another. In particular, connector assembly 50 may have one or more first conduit connectors 60 that are configured to be rapidly and removably coupled to one or more inflation manifolds 72 of manifold assembly 70. Patient support system 10 may optionally include a control unit 90 for controlling fluid flow through connector system 40 to inflate and/or deflate the mattress 20. Patient support system 10 may optionally further include one or more additional mattresses, each having a different structural configuration and/or therapeutic features and each interchangeably connectable to bed deck 30 via connector system 40.

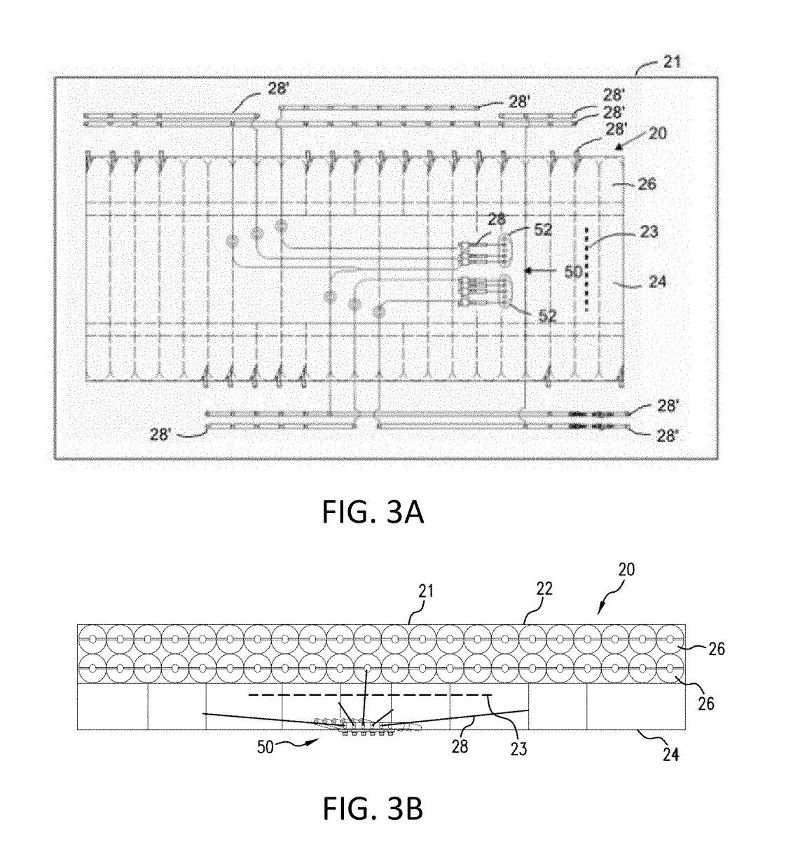

Inflatable mattress 20 may have an elongated patient support surface 22 on which a patient may be positioned and a mattress base 24 opposing the patient support surface 22. In the exemplary embodiments shown in FIGS. 3A-3B, mattress 20 may further include a plurality of inflatable cells 26, the inflation and/or deflation of which directly affect and dictate the topographical configuration of patient support surface 22, specifically the contour and shape of the patient support surface 22. By controlling and periodically adjusting the fluid pressure within the inflatable cells 26, rate of inflation of one or more inflatable cells 26, inflation timing for one or more inflatable cells 26, etc., and combinations thereof, it is possible to provide customized therapeutic treatment to a patient reclining on patient support surface 22, e.g., so as to prevent, reduce or treat decubitus ulcers and/or turn or otherwise reposition a patient to facilitate patient care and/or receipt of therapeutic treatment. Inflatable cells 26 may be constructed as inflatable bladders that are at least partially or fully positioned within an interior space of mattress 20, defined by the upper patient support surface 22, lower mattress base 24 and a mattress cover 21 encasing mattress 20. In one embodiment, inflatable cells 26 may be configured as fluid cells or a plurality of fluid tight inflatable bags, cushions, compartments or sections spaced apart from connector assembly 50 and forming, adjoining or otherwise positioned adjacent to patient support surface 22. In another embodiment, mattress 20 may include a plurality of internal compartments or sections accessible through a zipper, button, hook and other fastener and/or otherwise have a resalable opening 23 in mattress cover 21 capable of being opened and reclosed, where a plurality of inflatable cells 26 are located within one or more of the compartments at a location spaced apart from connector assembly 50 and adjoining or otherwise adjacent to patient support surface 22. Inflatable cells 26 may be connected to a fluid port or inflation port via a plurality of independent inflation cell conduits 28, including inflation cell conduit portions 28′. As shown in the exploded schematic diagram of FIG. 3, inflation cell conduit portions 28′ located within mattress cover 21 may be configured as conduit portions or conduit sections that are connected to one another to deliver fluid to one or more sections of mattress 20, specifically to independently deliver fluid to one or more groups of inflatable cells 26.

As best shown in the embodiment of FIG. 2, mattress base 24 is positioned on and supported by a bed deck 30 of bed frame 31. Bed deck 30 may be configured as an elongated, rigid mattress support platform elevated from the ground by one or more leg supports 32, wherein legs 32 extend from bed deck 30 towards and to the ground. In one embodiment, bed deck 30 may include multiple mattress support platform sections that collectively form the mattress support surface. Alternatively, bed deck 30 may be one of multiple platform sections forming part of bed frame 31 and supporting mattress base 24. In one embodiment, bed deck 30 together with a rail frame 34, extending along the head, foot, and sides of bed deck 30, may form a bed base having a tray like configuration for directly receiving and engaging mattress base 24. Mattress 20 may be supported on bed deck 30 such that mattress base 24 faces, directly contacts and is cradled within a recess formed by rail frame 34 and an upper surface of bed deck 30, thereby allowing the bed side and mattress side components of connector system 40 to directly interface and engage one another.

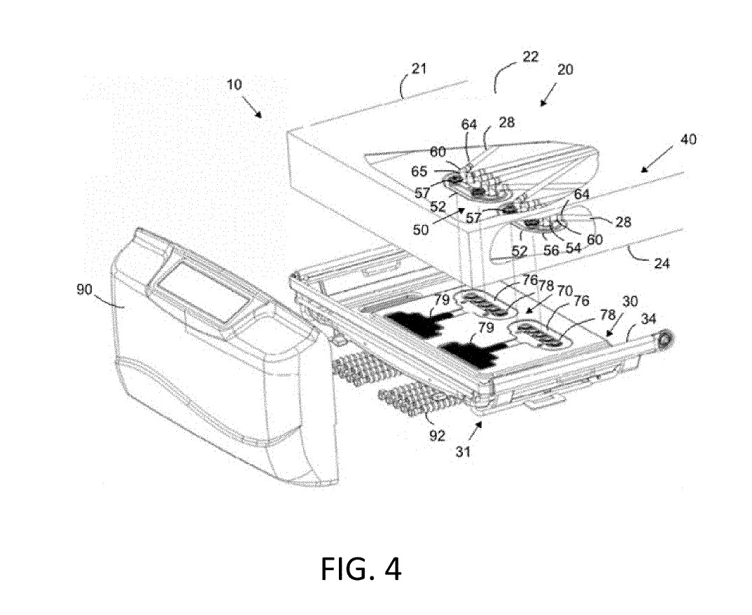

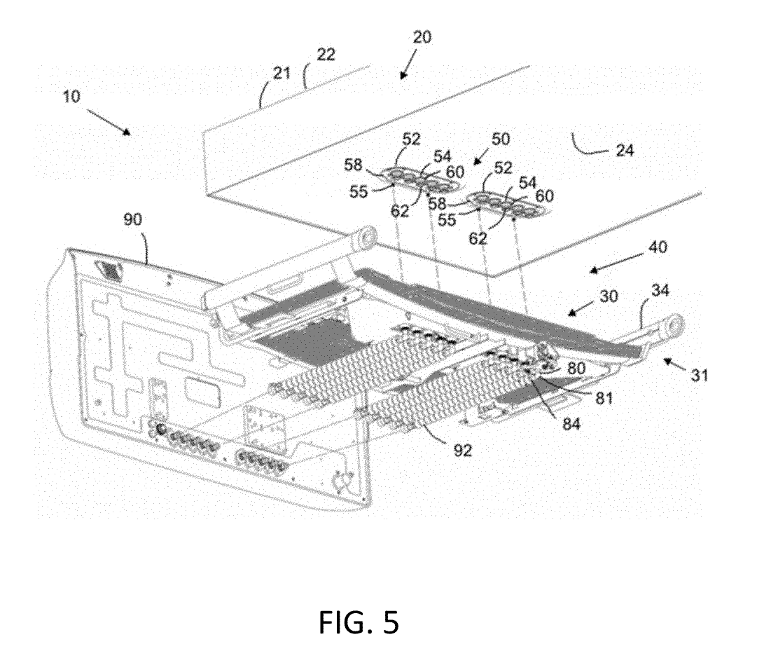

In the embodiment shown in FIGS. 4-5, connector system 40 may be configured as a quick connect system including a connector assembly 50 disposed at inflatable mattress 20 and a manifold assembly 70 disposed at bed deck 30, each configured to rapidly and detachably couple to one another. Connector assembly 50 may include one or more connector plates 52 having a rigid body with one or more connector plate openings 54 defined therein for receiving, aligning, orienting and securing one or more first conduit connectors 60 positioned therethrough. In the embodiment shown in FIGS. 4-5, connector assembly 50 includes two connector plates 52 positioned adjacent to one another and located at a foot support region of mattress 20 spaced apart from the perimeter of mattress 20. Connector plates 52 may be configured as rigid plates shaped and contoured to couple, fit or otherwise mate with a corresponding manifold plate 76 portion of bed deck 30, wherein connector plates 52 may be flush, inset or protrude from a surrounding surface of mattress base 24. In the embodiment shown in FIGS. 4-5, connector plates 52 may have a sufficiently large surface area that fully surrounds and provides sufficient spacing for a user to grip, manipulate and apply force to facilitate quick connect attachment of connector assembly 50 and manifold assembly 70. The rigidity of connector plate 52 functions to secure the connection between first conduit connectors 60 and manifold chamber 74 preventing leakage of fluid as well as facilitating user handling and rapid attachment of connector assembly 50 and manifold assembly 70. Each of the connector plates 52 have an upper plate member 56 joined to a corresponding lower plate member 58 by fasteners, such as rivets, bolts, screws, adhesives and heat sealing. A plurality of connector plate openings 54 are positioned through upper and lower plate members 56, 58, within which a plurality of first conduit connectors 60 are adjustably secured. Connector plates 52 facilitate the centralized grouping, organization and alignment of first conduit connectors 60 and the inflation ports formed by first conduit connectors 60 and inflation manifold 72. In an exemplary embodiment, each connector plate 52 provides a discrete mattress inflation port inlet site that is no greater than 2.5% of the surface area of the mattress base 24, wherein the connector plates 52 of connector assembly 50 are located proximate to one another and collectively do not exceed a surface area greater than 5% of the surface area of the mattress base 24. In one embodiment, at least substantially all the first conduit connectors 60 of connector system 40 and/or patient support system 10 may be gathered in a localized region; in one embodiment, at least substantially all the fluid inflation ports of patient support system 10 configured to affect a shape and/or contour of the patient support surface 22 are localized in a contiguous area that does not exceed about 5% of the surface area of mattress base 24. Connector plates 52 may be positioned adjacent to one another such that they are oriented parallel to one another, aligned so as to share the same longitudinal axis, longitudinal direction and/or aligned so as to be positioned along an axis perpendicular to the longitudinal axis or longitudinal direction of the mattress 20. In another embodiment, two or more connector plates 52 may be spaced apart from one another, but each still functions to provide a platform for gathering a plurality of first conduit connectors 60 at a substantially centralized region of mattress base 24. By grouping first conduit connectors 60 together in a collective, localized arrangement, attachment and removal of first conduit connectors 60 to the inflation manifold 72 is streamlined and made simpler, enabling faster and more efficient installation, detachment and exchange of mattresses 20 with respect to bed deck 30. This localized arrangement of first conduit connectors 60 facilitates the proper positioning of connector plates 52 with respect to manifold plate 76 so as to automatically align the plurality of first conduit connectors 60 with the plurality of manifold chambers 74 of inflation manifold 72 to allow for rapid connection, as discussed in further detail below. Furthermore, the arrangement of connector plate openings 54 and first conduit connectors 60 in one or more rows as well as the alignment and close proximity of the two connector plates 52 facilitate the organization of inflation cell conduits 28 and inflation cell conduit portions 28′ connected to and/or extending from first conduit connectors 60 to inflatable cells 26. For example, connector plate openings 54 and first conduit connectors 60 may be arranged in connector plate 52 such that tubing, hoses or other inflation cell conduits 28 extending between first conduit connectors 60 and inflation cells 26 do not cross over one another or otherwise become tangled. Connector plates 52 may also be positioned such that connector plate openings 54 and first conduit connectors 60 of the two connector plates 52 are arranged in one or more rows to further prevent tangling of inflation cell conduits 28.

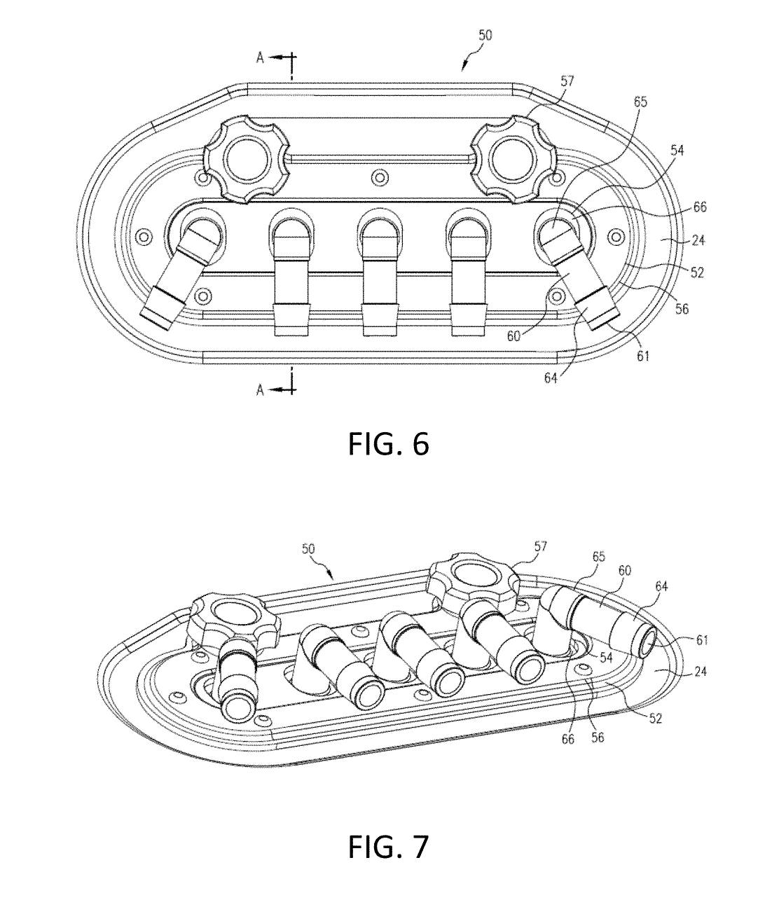

As shown in the embodiments of FIGS. 6-9, first conduit connector 60 has a rigid, hollow elongated conduit body with a central channel 61 extending therethrough for transporting fluid to and from mattress 20. The coupled first conduit connectors 60 and manifold chambers 74 of inflation manifold 72 form mattress inflation ports in fluid communication with mattress 20, specifically in fluid communication with the plurality of independently inflatable cells 26 of mattress 20, for inflating and/or deflating mattress 20. In one embodiment, the first conduit connectors 60 secured in connector plates 52 of connector assembly 50 transports fluids to at least substantially all of the inflatable cells 26 of mattress 20 that are configured to affect a configuration of patient support surface 22, specifically affect the shape and/or contour of the patient support surface 22, and/or inflate and/or deflate mattress 20. In an exemplary embodiment, first conduit connectors 60 of connector assembly 50 may enable quick and quiet inflation of mattress 20 within a period of about 5 minutes or less or about 3 minutes or less, wherein fluid flow rate through the first conduit connectors 60 may be up to about 65 L/minute, up to about 500 mL/minute or up to about 200 mL/minute. In another embodiment, the mattress inflation time may be about 20 minutes or less.

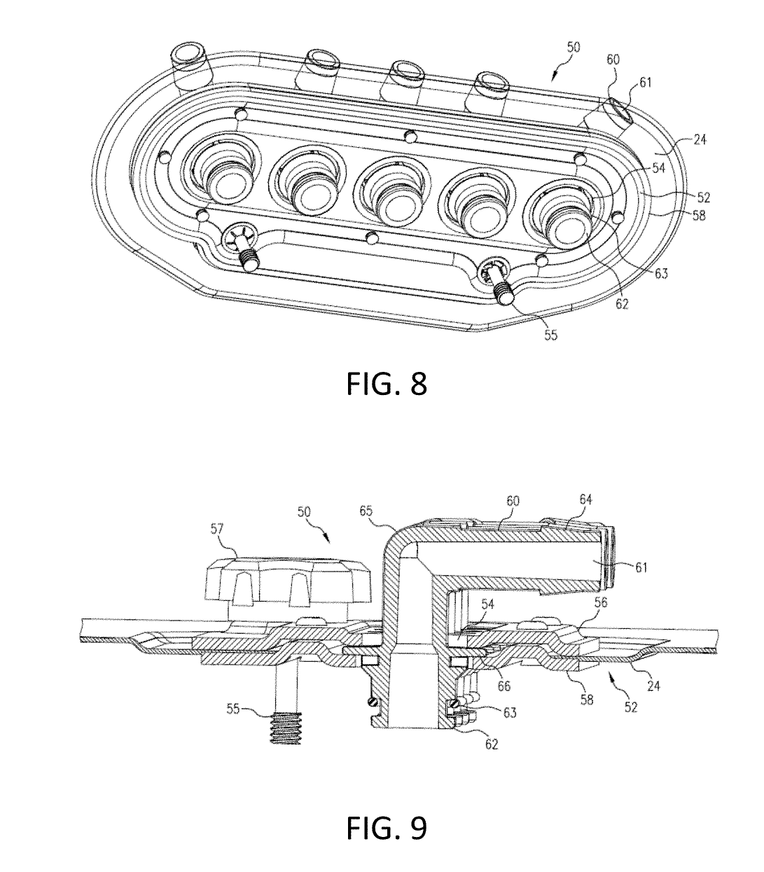

A first manifold connector mating end 62 of first conduit connector 60 may have a fastener configuration adapted for rapid connection to and detachment from corresponding manifold chambers 74 of manifold assembly 70. In one embodiment, manifold connector mating end 62 may be a quick connect fastener end suitable for plug in attachment and having a securement mechanism, such as a drawn down lever, latch, ratcheting mechanism, clamping mechanism, collar or split ring spring securing manifold connector mating end 62 to manifold chamber 74. In an exemplary embodiment, manifold connector mating end 62 may be configured as a male fastener forming a nozzle. FIGS. 8-9 shows an exemplary plug-in nipple configuration of manifold connector mating end 62, which may be configured and adapted to be inserted and securely friction fitted into manifold chambers 74 to form a mattress inflation port. In an alternative embodiment, manifold connector mating end 62 may be configured as a female fastener fitted about manifold chambers 74. Manifold connector mating end 62 of first conduit connector 60 may be at least partially positioned exterior to mattress 20, extending substantially orthogonal to and distally from connector plate 52 and mattress base 24 towards the upper surface of bed deck 30 directly facing mattress base 24. Optionally, a first seal 63, such as a gasket, O-ring or other sealing element, may be positioned about a portion of manifold connector mating end 62 to establish a fluid tight seal, preferably a gas tight or air tight seal, between first conduit connector 60 and manifold chamber 74 when connected to one another, as best shown in FIG. 13. In the embodiment shown in FIGS. 8-9, first seal 63 may be positioned within a circumferential recess formed about the perimeter of manifold connector mating end 62.

Referring to the embodiment of FIGS. 6-7, each first conduit connector 60 forms a separate fluid flow path and independently communicates with a corresponding inflatable cell 26 or set of inflatable cells 26. A proximal portion of first conduit connector 60 located within mattress 20 fluidly communicates with these inflatable cells 26. This proximal portion may include a first conduit connector elbow 65, such that this proximal portion is oriented substantially parallel to mattress base 24 and extends into the interior of mattress 20, terminating in a second mating end 64. Second mating end 64 is configured to be coupled to one or more of the inflatable cells 26 and inflation cell conduits 28 extending therefrom so as to establish a fluid tight seal, preferably an air or gas tight seal. In the embodiment of FIGS. 6-7, second mating end 64 has a tapered nozzle tip with a raised lip for friction fitting into a conduit or inflatable cell 26.

First conduit connectors 60 may be positionably adjustable and movably secured within connector plate openings 54. This feature facilitates the fine alignment and ease in connecting first conduit connectors 60 and manifold chambers 74, as described in further detail below, providing a degree of play and system flexibility to compensate for any misalignment during the process of attaching connector assembly 50 and manifold assembly 70, and/or to accommodate any dimensional tolerances or variances. The movable mounting of first conduit connectors 60 also allows for adjustability in the arrangement of the connection between first conduit connectors 60 and inflatable cells 26. In one embodiment, first conduit connectors 60 may be adjustably mounted to connector plate 52 by virtue of flanges 66 which are movably mounted to connector plates 52. Flange 66 extends radially from an exterior surface of the elongated conduit body towards a portion of the connector plate 52 forming the connector plate opening 54. A distal edge of flange 66 is movably mounted and floats between the portions of upper and lower plate members 56, 58 defining connector plate opening 54. Upper and lower plate members 56, 58 may form a space therebetween for receiving flange 66, wherein the edge of connector plate opening 54 is spaced apart from the perimeter of first conduit connector 60's elongated conduit body within connector plate opening 54. In one embodiment, the flange 66 can move laterally at least about 1 mm or more, 2 mm or more, 2.5 mm or more, 2.7 mm or more or 3 mm or more in the cavity formed between upper and lower plate members 56, 58 and in a plane parallel to upper and/or lower connector plate member 56, 58. Flange 66 may be constructed from plastic and may be rigid so as to be securely retained between upper and lower plate members 56, 58 and can be rotationally adjusted and laterally displaced between upper and lower plate members 56, 58 such that first conduit connectors 60 may be independently pivoted and swiveled within connector plate 52 with respect to one another.

As best shown in the embodiment of FIG. 9, connector assembly 50 further includes one or more optional system fasteners 55 for locking connector assembly 50 to manifold assembly 70. In an exemplary embodiment, system fastener 55 has an elongated fastener body 59 spaced apart from the plurality of first conduit connectors 60 and manifold chambers 74 and extending between and securing connector plate 52 to a surface of bed deck 30, identified herein as a manifold plate 76. For clarification, manifold plate 76 may be integrally formed with, attached to or otherwise part of bed deck 30, specifically an upper surface of bed deck 30. System fastener 55 may further include an actuator 57 to lock and unlock system fastener 55, such as a user actuated knob, handle, lever or catch. Exemplary system fasteners 55 may include latches, hooks and threaded fasteners, such as screws or bolts. In one embodiment, system fastener 55 may be a turning latch, such as a quarter turn locking mechanism. In the embodiment shown in FIGS. 6-7, two system fasteners 55 configured as screws are positioned through a hole in connector plate 52, manifold plate 76 and into the body of inflation manifold 72. A user may implement locking by manipulating actuator 57, here configured as a rotational knob, to advance the screw through connector plate 52, manifold plate 76 and inflation manifold 72.

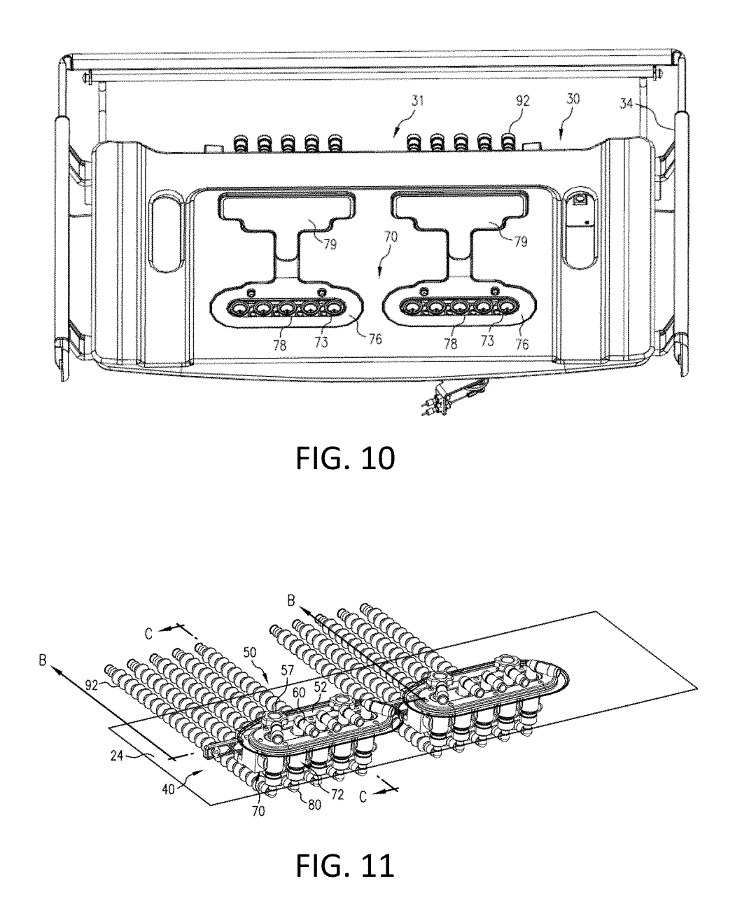

FIGS. 10-15 show an exemplary manifold assembly 70 configured to be rapidly and detachably coupled to connector assembly 50. In this embodiment, manifold assembly 70 includes an inflation manifold 72 and is at least partially positioned within bed deck 30. A first end of inflation manifold 72 is attached to bed deck 30 at the region of manifold plate 76 to facilitate connection with the manifold connector mating end 62 of first conduit connector 60. A second end of inflation manifold 72 is connected to a second conduit connector 80 in fluid communication with control unit 90.

As previously described, manifold plate 76 may be located at an upper surface of bed deck 30 and directly engages connector assembly 50. In the embodiment of FIG. 10, manifold plate 76 may be integrally formed and continuous with bed deck 30, forming an upper surface of bed deck 30. In another embodiment, manifold plate 76 may be a separate plate attached to bed deck 30. Manifold plate 76 may have a rigid structure configured to facilitate attachment to connector assembly 50 and alignment of the plurality of first conduit connectors 60 with the plurality of manifold chambers 74. Manifold plate 76 may be configured as a recessed surface within bed deck 30, as shown in FIG. 10, or may protrude outward with respect to bed deck 30 with a configuration adapted to facilitate mating with the correspondingly protruding or recessed shape of connector assembly 50, specifically connector plates 52, with respect to mattress base 24. In another embodiment, manifold plate 76 may further include with one or more grooves, ridges, recesses, valleys, lips and/or other contouring designed to facilitate attachment to connector assembly 50, such as friction fitted snap attachment with corresponding grooves, ridges, recesses, valleys, lips and/or other contouring of connector plate 52. For example, manifold plate 76 and connector plate 52 may have corresponding concentric, elliptical ridges and grooves graduated in height and/or depth that snap fit with respect to one another to facilitate mating and ensure a secure attachment therebween. One or more manifold plate openings 78 defined in manifold plate 76 frame permit direct access to manifold chambers 74 of inflation manifold 72 as well as align and facilitate attachment between manifold chambers 74 and first conduit connectors 60.

Manifold plate 76 and manifold plate opening 78 thus provide gross alignment and facilitate the plug-in attachment of the first conduit connectors 60 and connector assembly 50 to manifold chambers 74 and manifold assembly 70. In an exemplary embodiment, manifold plate 76 may have a single elongated manifold plate opening 78 flush with respect to an upper edge of manifold chambers 74 and open to a space exterior to bed deck 30.

When connector assembly 50 is not attached to manifold assembly 70, a manifold plate cover 79 may be positioned over manifold plate 76 to protect inflation manifold 72 when not in use. In the embodiment shown in FIG. 10, the illustrated two manifold plate covers 79 has the same shape and configuration as the two recessed manifold plate 76 such that the manifold plate covers 79 are flush with respect to the adjoining surfaces of bed deck 30 when positioned over manifold plate 76. Manifold plate covers 79 may be stored in one or more recesses or cavities of bed deck 30 adjacent to manifold plates 76. In one embodiment, manifold plate cover 79 may be movably attached to bed deck 30 such that it can be pivoted about a hinge or joint so as to be rotated with respect to or otherwise flipped over the hinge or joint to cover over manifold plate 76 and manifold plate opening 78.

Referring to the embodiment of FIGS. 10-15, manifold assembly 70 has two inflation manifolds 72, each having the same configuration as the manifold block shown in FIGS. 11-15 and extending through a depth of bed deck 30. Preferably, inflation manifold 72 may be a pneumatic manifold, such as a CPR valve manifold. Inflation manifold 72 may include a plurality of manifold chambers 74, each having an independent fluid flow path for transporting fluid to mattress 20 in order to inflate and/or deflate the plurality of independent inflatable cells 26. In one embodiment, manifold chamber 74 has a cylindrical configuration with a first conduit connector mating end 73 configured for rapidly and detachably coupling to manifold connector mating end 62 of first conduit connector 60. First conduit connector mating end 73 may be a female fastener configuration forming a receptacle for receiving the conduit connector plug. In one embodiment, first conduit connector mating end 73 may have a quick connect configuration suitable for plug in attachment and securement to manifold connector mating end 62. As shown, first conduit connector mating end 73 may have a flared, outwardly tapering chamfered lip to facilitate insertion of first conduit connector 60 in manifold chamber 74. When positioned within manifold chamber 74, manifold connector mating end 62 and first seal 63 is friction fitted and wedged in an upper portion of manifold chamber 74 to form a fluid tight seal. Optionally, first conduit connector mating end 73 may include a securement member such as a draw down lever, latch, ratcheting mechanism, clamping mechanism, collar or split ring spring securing manifold connector mating end 62 to manifold chamber 74. In an alternative embodiment, first conduit connector mating end 73 may be configured to be received within and form a fluid tight seal with respect to manifold connector mating end 62.

A manifold chamber second end 75 is coupled to and forms a fluid tight seal with respect to a second conduit connector 80. Second conduit connector 80 may have a rigid, hollow conduit body for transporting fluid between the manifold chambers 74 of inflation manifold 72 and control unit 90. In one embodiment, second conduit connector 80 may have the same or a similar configuration to that of first conduit connector 60. A manifold chamber mating end 82 of second conduit connector 80 may be received in, plugged in, disposed about or otherwise connected to manifold chamber second end 75 and may have the same shape, configuration as manifold connector mating end 62, including first seal 63. Second seal 83 positioned about an exterior circumferential surface of second conduit connector 80 forms a fluid tight seal with an interior surface of manifold chamber second end 75. A second end 84 of second conduit connector 80 extends through a lower surface of bed deck 30 such that it is positioned beneath and exterior to bed deck 30. In one embodiment, second end 84 may have a shape and configuration corresponding to or the same as second mating end 64. A distal portion of second conduit connector 80 exterior to bed deck 30 may include a second conduit connector elbow 81, such that this distal portion is oriented substantially parallel to a lower surface of bed deck 30, terminating in second end 84. One or more fluid supply conduits 92 may be connected to second end 84 and a control unit 90 forming a fluid tight seal, preferably a gas tight or air tight seal, for purposes transporting fluid to inflation manifold 72. In one embodiment, fluid supply conduits 92 may be configured as corrugated, extendible conduits or hoses.

Inflation manifold 72 may optionally further include one or more valves to prevent fluid leakage through manifold chamber 74 of inflation manifold 72 and/or facilitate deflation of mattress 20. By way of example, one or more values may optionally be located within manifold chamber 74, first conduit connector 60 or any combinations thereof.

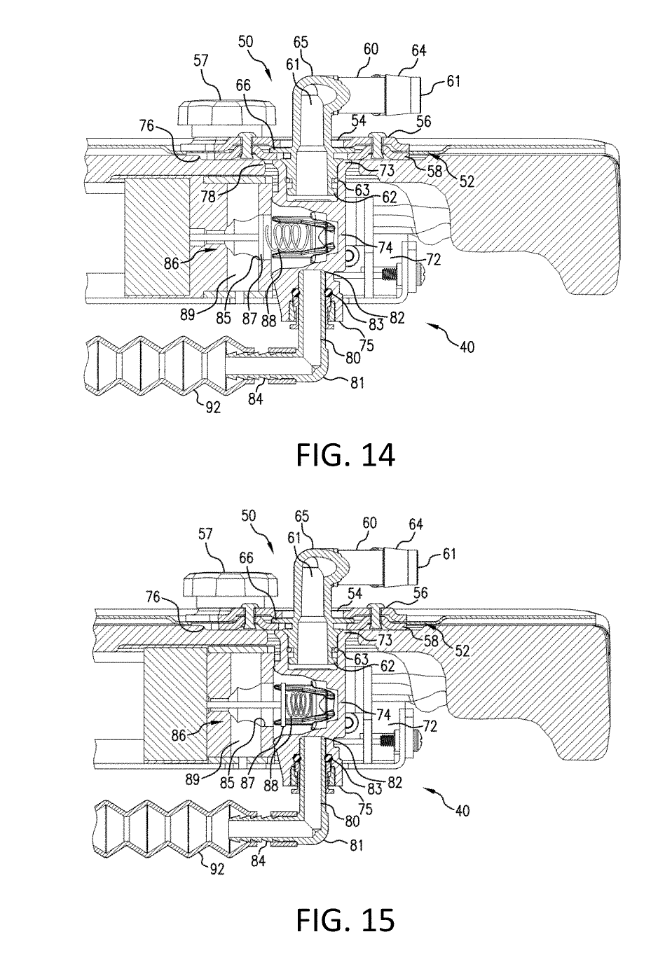

In the embodiment of FIGS. 14-15, the system may further include a plurality of dump valves 86, each independently operatively associated with a corresponding manifold chamber 74 to enable the rapid and simultaneous release of fluid from mattress 20 for purposes of facilitating the control and regulation of the degree of inflation of mattress 20 as well as for purposes of deflating mattress 20. In this embodiment, dump valve 86 includes a spring biased stopper or stop member 87 sealing a valve opening 85 in the wall of manifold chamber 74. A compression spring 88 braced against an opposite wall of manifold chamber 74 biases stop member 87 against the valve opening 85 in the wall of manifold chamber 74, thereby effectively plugging valve opening 85, as shown in FIG. 14. A user may subsequently manually activate or control unit 90 may direct a manifold actuator to push against stop member 87 in the opposite direction of spring 88. Once opened, as shown in FIG. 15, fluid in manifold chamber 74 is permitted to flow through valve opening 85 and into an adjoining release valve chamber 89 that is open to the atmosphere or otherwise funneled to one or more fluid outlet ports for purposes of rapidly venting the fluid within mattress 20.

Patient support system 10 may optionally further include a control unit 90 that functions as an inflation controller and may be removable or integral with bed frame 31. In an exemplary embodiment, control unit 90 may be configured as an air box including one or more microcontrollers operatively associated with a power source, pump and pneumatic manifold of control unit 90 as well as inflation manifolds 72 and dump valves 86 for purposes of regulating fluid flow and the degree of inflation of mattress 20. In particular, control unit 90 functions to regulate and control the supply fluid, specifically air, to and the egress of fluid from inflation manifold 72 and manifold assembly 70 thus enabling inflation of mattress 20 and customized patient therapy. Control unit 90 may include a pressure feedback loop for continuously monitoring, controlling, maintaining and adjusting the fluid pressure in mattress 20 and inflatable cells 26. In one embodiment, the control unit 90 and its processors and microcontrollers directly interfaces with a hospital's computer network and records, a patient positioned on mattress 20, bed frame 31, mattress 20, manifold assembly 70, connector assembly 50 and/or combinations thereof to receive and analyze the system as well as patient specific information for purposes of providing responsive, real time, customized patient therapy.

The above described exemplary embodiments of connector system 40 and patient support system 10 have a number of advantageous features, such as the modular system design including an inflatable mattress 20 detachably coupled to an integral bed frame inflation manifold 72 that allows for direct system interface with an control unit 90 as well as the ability to attach, remove and interchange a plurality of inflatable mattresses 20 as desired. Furthermore, the unique placement of connector assembly 50 at the mattress base 24; the direct engagement between the mattress connector assembly 50 and bed deck manifold assembly 70; the design of first conduit connectors 60 so as to be independently adjustable with respect to one another and movably connected to connector plate 52 and mattress base 24; the rapid coupling arrangement of connector assembly 50 and manifold assembly 70; and the collective grouping of the first conduit connectors 60 and manifold chambers 74 to centralize the mattress inflation ports all facilitate the rapid, detachable, adjustable and simultaneous connection and removal of a plurality of mattress first conduit connectors 60 to a plurality of corresponding bed deck manifold chambers 74.

The present application is also directed to a method for using the connector system 40 of patient support system 10 to attach, remove and interchange various mattresses 20 with respect to bed deck 30 so as to allow for fluid transport therebetween. The method involves rapidly attaching and locking the first conduit connectors 60 of connector assembly 50 to the manifold chambers 74 of manifold assembly 70, adjusting the position of one or more first conduit connectors 60, inflating mattress 20, deflating mattress 20 and exchanging mattress 20 with another mattress.

In an exemplary embodiment, to attach mattress 20 to bed deck 30 via connector system 40, a user accesses an internal space of a deflated mattress 20 through mattress cover opening 23, such as by unzipping the mattress cover 21, to access upper plate member 56 of connector plate 52. Connector plate 52 may then aligned and positioned directly above the portion of bed deck 30 forming manifold plate 76 so that the plurality of first conduit connectors 60 of the one or more connector plates 52 are oriented to be inserted directly into the plurality of manifold plate openings 78 of the one or more inflation manifolds 72. Connector plate 52 may subsequently be positioned on, received in the recess of and directly engage manifold plate 76 such that the plurality of first conduit connectors 60 are simultaneously inserted and plugged into first conduit connector mating ends 73 of manifold chambers 74. Any nominal alignment errors between manifold connector mating ends 62 of first conduit connectors 60 and the first conduit connector mating ends 73 of manifold chambers 74 may be addressed, corrected and compensated for by the movable mounting of first conduit connectors 60 to connector plate 52, which provides a degree of system flexibility and play to facilitate rapid attachment. As described, the relative positioning and mating of connector plate 52 and manifold plate 76 provides gross alignment of manifold connector mating ends 62 and first conduit connector mating ends 73 while the movable connector plate mounting of first conduit connectors 60 provides fine alignment of manifold connector mating ends 62 and first conduit connector mating ends 73. The outwardly flared lips of first conduit connector mating ends 73 assists in guiding the manifold connector mating ends 62 into manifold chambers 74. In another embodiment, corresponding one or more grooves, ridges, recesses, valleys lips and other contouring of a lower surface of connector plate 52, i.e. lower plate member 58, and an upper surface of manifold plate 76 enable connection by friction fitting or snap fitting connector assembly 50 to manifold assembly 70. Once attached, lower plate member 58 directly contacts and rests against an upper surface of manifold plate 76 while first conduit connector mating end 73 abuts up against the portion of lower plate member 58 extending into and defining manifold plate opening 78. Additionally, first seal 63 positioned about an exterior circumferential surface of first conduit connector 60 forms a fluid tight seal with an interior surface of manifold chamber 74.

Connector assembly 50 and manifold assembly 70 may be subsequently locked once coupled. For example, a user may actuate system fastener 55 to secure connector plate 52 to manifold plate 76. In the embodiment shown in FIGS. 5-8, system fastener 55, configured as a screw, extends through connector plate 52, manifold plate 76 and locks into the body of inflation manifold 72 upon turning actuator 57, configured here as a rotating knob.

If not preassembled, second mating end 64 of first conduit connector 60 may be inserted in, plugged in, coupled to or otherwise mate with inflation cell conduit 28 and/or inflatable cells 26. Each first conduit connector 60 of connector assembly 50 may be coupled to a different inflatable cell 26 or set of inflatable cells 26 enabling independent inflation for purposes of providing customized and various types of patient therapy. First conduit connectors 60, movably mounted to connector plate 52 and mattress base 24, can be pivoted, rotated and laterally displaced with respect to connector plate 52 and mattress base 24 to facilitate the connection with the plurality of inflation cell conduits 28 and inflatable cells 26. Additionally, each of the first conduit connectors 60 may be independently movably adjusted with respect to one another to further facilitate said connection. Mattress cover 21 may be subsequently zipped-up or otherwise resealed and closed.

Control unit 90, fluid supply conduit 92 and manifold assembly 70 may be pre-assembled as part of an integral bed frame 31. Alternatively, these components may be attached and connected to the coupled manifold assembly 70 and connector assembly 50. Once assembled, mattress 20, bed deck 30 and control unit 90 may communicate pneumatically through the inflation manifolds 72 integrated in bed deck 30 of bed frame 31, thereby allowing control unit 90 to manage patient therapy provided by the mattress 20. For example, a user may enter the desired settings, a patient's physiological parameters and/or a patient's therapeutic needs into control unit 90 to determine the appropriate degree of inflation of inflatable cells 26 and/or mattress 20. As directed by control unit 90, a fluid, such as air, may be pumped into fluid supply conduits 92 via control unit 90 through second conduit connectors 80, inflation manifolds 72, first conduit connectors 60, inflation cell conduits 28 and into inflatable cells 26. Control unit 90 may be used to periodically adjust the degree of inflation, rate of inflation and/or inflation cycles of one or more inflatable cells 26.

To remove or exchange mattress 20, a user may manually initiate or control unit 90 may be used to initiate deflation of mattress 20. In one embodiment, this process involves activating an actuator of the manifold that displaces spring biased stop member 87 from valve opening 85. Once displaced, fluid within inflatable cells 26 as well as within the internal lumen formed by inflation cell conduits 28, first conduit connectors 60 and manifold chambers 74 escape through valve opening 85 and into release valve chamber 89. The fluid is subsequently vented from release valve chamber 89 into atmosphere or otherwise funneled to one or more fluid outlet ports.

The deflated mattress 20 may be quickly removed by opening mattress cover 21, accessing connector plate 52 and unlocking system fastener 55. Connector plate 52 may then be lifted from manifold plate 76, separating first conduit connectors 60 from inflation manifold 72. Deflated mattress 20 may then be folded and stored for later use.

Once mattress 20 is removed, control unit 90 can either be uninstalled or turned off. Additionally manifold plate covers 79 may be pivoted or rotated to be positioned over manifold plate 76 and the manifold plate openings 78 to protect the inflation manifold 72 from damage and debris ingress. The bed is thus ready to be used with any standard mattress. Alternatively, inflatable mattresses having the same connector assembly 50 and different configurations and/or therapeutic features can be coupled to bed deck 30 and manifold assembly 70.

The foregoing description has been presented for the purpose of illustration and description only and is not to be construed as limiting the scope of the invention in any way. The scope of the invention is to be determined from the claims appended hereto.

1. An inflatable mattress comprising:
a patient support surface;
a mattress base opposing the patient support surface; and
a connector assembly disposed through the mattress base, the connector assembly comprising:
one or more connector plates comprising a plate body with one or more openings defined therethrough; and
one or more conduit connectors comprising a quick connect fastener end detachably connectable to an inflation manifold of a bed deck, wherein the at least one conduit connector is positioned through the at least one opening and movably attached to the at least one connector plate.

2. The mattress of claim 1, wherein the connector assembly further comprises a plurality of the one or more conduit connectors, wherein at least two of the plurality of conduit connectors are movably connected to the at least one connector plate and independently movable with respect to one another.

3. The mattress of claim 1, wherein the least one conduit connector is pivotally connected to and/or movably attached to the at least one connector plate so as to be capable of vertical and/or lateral displacement within the at least one opening.

4. The mattress of claim 3, wherein the at least one conduit connector further comprises an elongated body and a flexible flange extending from an exterior surface of the elongated body towards the portion of the at least one connector plate defining the one or more openings, wherein the elongated body is spaced apart from the portion of the at least one connector plate defining the one or more openings.

5. The mattress of claim 2, wherein the at least one connector plate further comprises an upper plate member and a lower plate member with the one or more openings defined therethrough and wherein the flange is movably secured between a portion of the upper and lower plate members defining the one or more openings.

6. The mattress of claim 4, wherein a ratio of a width of the at least one opening to a width of a portion of the elongated body within the at least one opening is about 1.10 to about 1.5

7. The mattress of claim 2, wherein the connector assembly further comprises a fastener capable of reversibly locking the connector assembly to the inflation manifold and wherein the fastener comprises an actuator located within an interior space of the mattress and accessible through a sealable opening of the mattress.

8. The mattress of claim 2, wherein the connector assembly further comprises a fastener capable of reversibly locking the connector assembly to the inflation manifold and wherein the fastener is spaced apart from the one or more conduit connectors and extends through the at least one connector plate and is capable of engaging the inflation manifold.

9. The mattress of claim 8, wherein the fastener is selected from the group consisting of: a threaded fastener, a latch, and a hook.

10. The mattress of claim 2, further comprising at least two or more connector plates arranged in a group, wherein the plurality of conduit connectors are arranged in the two or more connector plate and wherein the connector assembly substantially centralizes a location of inflation port inlets of the mattress.

11. The mattress of claim 2, further comprising a plurality of inflatable cells and wherein the connector assembly is in fluid communication with at least substantially all of the inflatable cells of the mattress that affects a shape and/or contour of the patient support surface.

12. A system comprising the mattress of claim 2 and a bed deck supporting the inflatable mattress, wherein the inflation manifold is disposed at least partially within the bed deck.

13. The system of claim 12, further comprising an inflation control unit and a conduit extending between the inflation control unit and the inflation manifold to deliver a fluid from the inflation control unit to the inflation manifold for inflating the mattress.

14-26. (canceled)

27. A bed deck comprising:
a platform body for supporting a length of an inflatable mattress;
one or more openings defined in an upper surface of the platform body;
a manifold assembly disposed at least partially within the platform body, the manifold assembly comprising:
one or more inflation manifolds comprising one or more manifold chambers, wherein a fastener end of the one or more manifold chambers is accessible through the one or more openings and is configured to rapidly and detachably couple to one or more mattress conduit connectors for inflating the mattress; and
one or more manifold conduit connectors extending from the one or more manifold chambers and through a lower surface of the platform body.

28. (canceled)

29. The bed deck of anyone of claims 27, wherein the platform body comprises a recess for receiving and engaging a portion of a connector plate of the mattress containing the one or more mattress conduit connectors and wherein the one or more openings is defined within the recess.

30. The bed deck of claim 29, wherein the manifold assembly further comprises a manifold cover pivotally attached to the platform body and capable of being positioned over the fastener end of the one or more manifold chambers.

31. The bed deck of claim 28, wherein the manifold assembly further comprises a fastener mating feature spaced apart from the at least one manifold chamber to lock the connector assembly to the at least one inflation manifold.

32. A patient support system comprising:
the bed deck of claim 27 comprising a plurality of manifold chambers; and
the mattress comprising a plurality of the mattress conduit connectors, wherein the plurality of mattress conduit connectors comprise a quick connect fastener end capable of being rapidly and detachably coupled to the plurality of manifold chambers.

33-46. (canceled)

47. A method for using a patient support system comprising:
coupling a plurality of conduit connectors of a connector assembly disposed through a mattress base of an inflatable mattress to a corresponding plurality of manifold chambers of one or more inflation manifold of a bed deck,
wherein the step of coupling comprises placing the mattress on or above the bed deck such that the plurality of conduit connectors are aligned with the plurality of manifold chambers and simultaneously inserting the plurality of conduit connectors into the plurality of manifold chambers.

48. (canceled)

49. The method of claim 47, further comprising opening a portion of the mattress to access the fastener located within an interior space of the mattress and subsequently closing the opening of the mattress after attaching the connector assembly to the one or more inflation manifolds.

50-56. (canceled)
